(19) United States
(12) Patent Application Publication
(10) Pub. No.: US 2021/0032466 A1
(43) Pub. Date: Feb. 4, 2021

(54) USE OF POLYAMIDE MOLDING COMPOUNDS TO REDUCE COATING FORMATION IN THERMOPLASTIC PROCESSING, POLYAMIDE MOLDING COMPOUND AND METHOD FOR PRODUCING USEFUL OBJECTS

(71) Applicant: EMS-PATENT AG, Domat/Ems (CH)

(72) Inventor: Georg STÖPPELMANN, Bonaduz (CH)

(73) Assignee: EMS-PATENT AG, Domat/Ems (CH)

(21) Appl. No.: 16/956,579

(22) PCT Filed: Dec. 17, 2018
(86) PCT No.: PCT/EP2018/085122

§ 371 Date: Jun. 20, 2020

(30) Foreign Application Priority Data
Dec. 22, 2017 (EP) 17210042.2

(51) Int. Cl. C08L 77/06

(52) U.S. Cl. CPC C08L 77/06; C08L 2205/025; C08L 2205/03

(57) ABSTRACT

The invention relates to the use of thermoplastic polyamide molding compounds to reduce the formation of solid deposits and/or coatings on tools used in thermoplastic shaping to form useful objects in discontinuous processes, in particular in injection molding, and used in continuous processes such as extrusion to form films, fibers, tubes and casings. The molding compounds used are based on polyamides which are largely based on the polyamide units (616, 516) or (916). By virtue of the use of the polyamide molding compounds according to the invention, the solid deposits and/or coatings that otherwise commonly occur in the further processing of polyamide (12) during injection molding or during extrusion, are greatly reduced or prevented.

### TECHNICAL FIELD

The present invention relates to the use of thermoplastic polyamide moulding compounds for reducing the formation of solid material deposits and/or coatings in the moulds used during thermoplastic reshaping to form everyday articles in discontinuous processes, in particular in injection moulding, and in continuous processes such as extrusion to form films, fibres, pipes and coverings. The moulding compounds used are based on polyamides which are based predominantly on the polyamide units 616, 516 or 916. By using the polyamide moulding compounds according to the invention, the solid material deposits and/or coatings which are otherwise normal with polyamide 12 are greatly reduced or avoided during further processing in injection moulding or in extrusion.

### STATE OF THE ART

Polyamide melts have, in the thermodynamic equilibrium state, specific concentrations of linear and possibly cyclic monomers and also linear and cyclic oligomers and also water. The low-molecular components affect the processibility of the products. During injection moulding- or extrusion processes, residual monomers, in particular lactams and cyclic oligomers, evaporate and, because of the formation of solid material deposits and coatings, are disruptive in the hereby used moulds. According to the type of polyamide, the production- and processing conditions, in addition low-molecular decomposition products must be taken into account with respect to formation of the coating.

Therefore, it is desirable to remove or to avoid the above-mentioned low-molecular components and oligomers as far as possible so that, during subsequent thermoplastic processing, solid material deposits or coatings are no longer produced.

Amongst the polyamides, PA12 is distinguished by an especially interesting property profile. Thus polyamide 12 can be modified in the most varied of ways, and the resulting moulding compounds can thereafter be reshaped excellently thermoplastically in injection moulding and extrusion processes to form everyday articles of high practical value. Polyamide 12 corresponds in total to the type of polyamides, the properties of which are affected least in practical use with change of temperature and humidity.

One problem is however that, during the normal, hydrolytic polymerisation process/autoclave process, the monomer conversion is effected only up to approx. 99.5% and the remaining residual lactam in the polymer is not readily soluble so that, in particular during processing from the melt, but also in subsequent practical use, the result is sweating out and sublimation of lactam 12 (LC12), in particular on cooled surfaces, e.g. the surfaces of tools and finished parts, and hence results in coating formation. Because of the high melting point of lactam 12, such sublimates often form disruptive deposits which, in particular when further additions migrate to the surface, can cause process disturbances with surface damage and hence production interruptions and also so-called “black spots” can be formed.

Known measures for reducing and eliminating lactam 12 residual content are e.g. melt- and solid phase postcondensation with vacuum effect and also liquid extraction processes or precipitation out of solution. Even these processes, in which lactam evaporates with heat effect, can be disturbed by the lactam sublimate. In addition, lactam mists are readily inflammable and the processes require special precautionary measures. In addition, the additional thermal stress can damage the polymer. During thermoplastic processing of polyamide 12 moulding compounds in the injection moulding method and in extrusion, the formation of solid material deposits, which consist in particular of lactam 12 (LC12), is disadvantageous.

In order to reduce the coating formation of polyamide 12 moulding compounds, EP 1 550 684 A2 proposes the addition of small quantities of polyamide-typical plasticisers or aprotic solvents. As a result, in fact the formation of a solid coating is avoided, however a viscous film with the dissolved residues adheres to the produced objects, which is tolerable only for a few applications. In addition, these moulding compounds always include solvents or plasticisers.

### OBJECT OF THE INVENTION

Users who further process polyamide moulding compounds to form e.g. moulded articles and wish to be certified, e.g. according to the standard group ISO 14000, are obliged to use sustainable operations. They produce for example life cycle analyses (life cycle assessment, LCA) about the CO₂ balance of products. A short time span between release of CO₂ (source) and renewed immobilisation (sink) contributes thereto, as is possible by the use according to the invention of biologically renewable raw materials with the indicated values for the biocomponent. The person skilled in the art is therefore confronted with the problem of requiring to use ecologically advantageous materials which have been associated to date with disadvantageous material properties. The invention, in one embodiment, represents a teaching for overcoming this problem in this respect, since it therefore surprisingly makes available an unexpectedly high-quality polyamide as material which is nevertheless ecologically essentially harmless because it is constructed extensively of renewable raw materials.

It is therefore the object of the present invention to provide thermoplastic polyamide moulding compounds which extensively have a property (e.g. water absorption, thermal and mechanical properties) and processing profile comparable to polyamide 12, have a biocomponent of at least 60% which however, in comparison with PA 12, has a significantly lower tendency towards solid material deposits during thermoplastic reshaping. Extensively comparable with respect to the mechanical properties thereby means the values for breaking resistance, breaking elongation and also impact- and notch impact strength, relative to an otherwise identical moulding compound but based on PA 12, are reduced no more than preferably 10%.

### PRESENTATION OF THE INVENTION

The previously mentioned object is achieved with the use according to patent claim 1, a polyamide moulding compound according to patent claim 10 and also a method according to patent claim 11. The dependent patent claims thereby represent advantageous developments.

The solution to this object is thereby achieved by a polyamide moulding compound being used, comprising or consisting of the following components
(A) 37-100% by weight of a polyamide mixture consisting of components (A1), (A2) and (A3),
   (A1) 50-100% by weight of at least one aliphatic polyamide which comprises at least up to 50% by mol of at least one polyamide unit selected from the group consisting of 616, 916 and 516 or consists hereof; and
   (A2) 0-50% by weight of at least one transparent polyamide VX/WX/VY/WY/Z, at least one of the polyamide units WX or WY being present and the abbreviations V to Z being derived from the following molecules: V: acyclic, aliphatic diamine with 6 to 12 carbon atoms; W: cycloaliphatic diamine; X: at least one acyclic, aliphatic dicarboxylic acid with 9 to 18 carbon atoms, at least one acyclic, aliphatic dicarboxylic acid with 16 carbon atoms (X1) constituting at least 50% by mol of all dicarboxylic acids X; Y: aromatic dicarboxylic acids, Z: lactams and aminocarboxylic acids with 6 to 12 carbon atoms;
   (A3) 0-50% by weight of at least one aliphatic polyamide selected from the group consisting of PA11, PA12 and P10U with U=amidically bonded acyclic, aliphatic dicarboxylic acid with 9 to 18 carbon atoms;
   the sum of (A1) to (A3) producing the totality of component (A);
(B) 0-60% by weight of fillers and/or reinforcing materials;
(C) 0-3% by weight of aids and/or additives
   the sum of components (A) to (C) constituting 100% by weight,
   for reducing solid material deposits and/or coatings during thermoplastic reshaping of everyday articles in discontinuous processes, in particular in injection moulding, and in continuous processes, such as extrusion, to form films, fibres, pipes and coverings.

Surprisingly, it was established that the new use of the polyamide moulding compound according to the invention, in contrast to EP 1 550 684 A2, leads to deposits of the polyamide moulding compound being extensively prevented in the moulds used during the processing. As additional effects, not only sublimation of the residual monomers or oligomers remaining in the polyamide 12 or the decomposition products formed during the processing are reduced but also the addition of a “solvent”, which is supposed to liquefy these coatings, is avoided. Hence the objects produced according to the invention are extensively free of solid and liquid coatings.

The moulding compounds according to the invention have in addition a high biocomponent according to ASTM D6866-06a of at least 60%. The biocomponent according to ASTM D6866-06a is the measure for the proportion of non-fossil, i.e. renewable carbon. The biocomponent is thereby derived from the ratio of the carbon isotopes C12 and C14. Since this ratio differs significantly in fossil and renewable raw materials, the biocomponent of the polyamide moulding compounds according to the invention can be established metrologically simply as an unequivocally product-characterising property.

For example the biocomponent for PA 616 is 69%, for PA 916, 62%.

The moulding compounds according to the invention have hence not only better mechanical properties, compared with conventional polyamide moulding compounds, in particular PA12, but can also be obtained up to a substantial amount from renewable raw materials.

The subsequent embodiments relate to preferred embodiments of the moulding compounds according to the invention and can be applied individually or in combination to the above-indicated moulding compound.

Component (A)

According to a preferred embodiment of the present invention, the proportion of component (A), relative to the total weight of components (A) to (C) or relative to the polyamide moulding compound, is in the range of 42 to 90% by weight, particularly preferably 47 to 80% by weight and particularly preferably 47 to 79.9% by weight.

It is hereby preferred if the polyamide mixture (A) consists of 50 to 95% by weight, preferably of 60 to 90% by weight and in particular 65 to 85% by weight of polyamide (A1), and of 5 to 50% by weight, particularly preferably of 10 to 40% by weight and in particular of 15 to 35% by weight of polyamide (A2), polyamide (A3) or of a mixture of polyamides (A2) and (A3).

It is hence possible that the polyamide mixture (A), in addition to the necessarily present component (A1), also comprises either component (A2) or (A3) or both of components (A2) and (A3). It is hereby preferred that the sum of components (A2) and (A3) is 5 to 50% by weight, preferably 10 to 40% by weight and in particular 15-35% by weight, relative to the sum of components (A 1) to (A3).

For particular preference, the proportion of polyamide (A1) is 50 to 90% by weight, preferably 60 to 80% by weight, the proportion of polyamide (A2) 5 to 25% by weight, particularly preferably 10 to 20% by weight, and the proportion of polyamide (A3) 5 to 25% by weight, particularly preferably of 10 to 20% by weight, of the total component (A).

Component (A1)

Component (A1) concerns at least one aliphatic polyamide, which consists at least up to 50% by mol, preferably up to 60 or 80% by mol and in particular exclusively (up to 100% by mol), of the polyamide units PA616, PA516 or PA916.

The polyamide units, which can be present in addition to the polyamide units 616, 916 or 516 in component (A1), concern preferably polyamide units 6S, 9S or 10S, S standing respectively for an acyclic, aliphatic dicarboxylic acid with 9 to 18, preferably 10 to 16 carbon atoms. Polyamide units 6S and 10S are thereby particularly preferred, S standing for an acyclic, aliphatic dicarboxylic acid with 10 to 14, or they concern in particular polyamide units 610, 612, 614, 1010, 1012 and 1014.

The aliphatic dicarboxylic acid (S) is selected preferably from the group consisting of 1,9-nonanedioic acid, 1,10-decanedioic acid, 1,11-undecanedioic acid, 1,12-dodecanedioic acid, 1,13-tridecanedioic acid, 1,14-tetradecanedioic acid 1,15-pentadecanedioic acid, 1,16-hexadecanedioic acid, 1,17-heptadecanedioic acid, 1,18-octadecanedioic acid and mixtures hereof. Open-chain, aliphatic dicarboxylic acids (S) selected from the group consisting of dicarboxylic acids with 10 to 16 carbon atoms, in particular 1,10-decanedioic acid, 1,12-dodecanedioic acid, 1,14-tetradecanedioic acid and mixtures hereof, are particularly preferred.

In a further embodiment, component (A1) is preferably selected from homopolyamides 616, 516 or 916, and also copolyamides 516/616, 516/916, 616/1016, 616/610, 616/612 or 616/614 and mixtures thereof, the proportion of 616, 516 or 916 in the copolyamides constituting at least 50% by mol, preferably at least 60% by mol and in particular 80% by mol. These polyamides or copolyamides can form respectively alone component (A1), however also mixtures of at least two of the previously mentioned polyamides or copolyamides are possible.

Polyamides 616, 616/1016 or 616/614 are particularly preferred, the proportion of 616 in the copolyamides 616/1016 and 616/614 constituting at least 50% by mol, preferably at least 60% by mol and in particular 80% by mol.

Component (A1) is formed by polycondensation of the diamines 1,5-pentanediamine, 1,6-hexanediamine and/or 1,10-decanediamine and also the aliphatic dicarboxylic acids 1,16-hexadecanedioic acid and 1,18-octadecanedioic acid.

With respect to processibility, it proves advantageous if the aliphatic polyamide of component (A1), in particular if this is selected as PA616, has a solution viscosity (determined according to ISO 307:2013 on a solution of 0.5 g polymer granulate in 100 ml m-cresol at a temperature of 20° C.) in the range of ηᵣₑₗ=1.6 to 3.0, preferably in the range of ηᵣₑₗ=1.7 to 2.7, in particular in the range of 1.80 to 2.30.

It is particularly preferred if component (A1) is predominantly based on monomers, which are available from renewable raw materials, so that the bioproportion according to ASTM D6866-068a of polyamide (A1) is at least 60% by weight, preferably at least 65% by weight and in particular at least 68% by weight.

Component (A2)

Component (A2) concerns at least one transparent polyamide of formula VX/WX/VY/WY/Z, at least one of the polyamide units WX or WY requiring to be present (and hence the units VX, VY and Z are optional) and the units V, W, X, Y, and Z being derived from the following molecules, which are present amidically bonded in the polyamide according to components (A2):

(V): acyclic, aliphatic diamine with 6 to 12 carbon atoms;

(W): cycloaliphatic diamine;

(X): acyclic, aliphatic dicarboxylic acid with 9 to 18 carbon atoms, at least one acyclic, aliphatic dicarboxylic acid with 16 carbon atoms (X1) constituting at least 50% by mol of all the dicarboxylic acids X;

(Y): aromatic dicarboxylic acids; (Z): lactams, aminocarboxylic acids.

By transparency in the designation of component (A2), there should generally be understood that the light transmission of a plate manufactured from component (A2) of a thickness of 2 mm is at least 88%, preferably at least 90%, if the transmission is determined by means of a UV/VIS-spectrometer at a wavelength of 600 nm.

According to a preferred embodiment, diamine (V) is selected from the group consisting of hexanediamine, in particular 1,6-hexanediamine, 2,2,4-trimethyl-1,6-hexamethylenediamine, 2,4,4-trimethyl-1,6-hexamethylenediamine, nonanediamine, in particular 1,9-nonanediamine, 2-methyl-1,8-octanediamine, 1,10-decanediamine, 1,11-undecanediamine, 1,12-dodecanediamine and mixtures hereof. Open-chain, aliphatic diamines (V) selected from the group consisting of diamines with 6 to 10 carbon atoms, in particular 1,6-hexanediamine, 1,9-nonanediamine, 1,10-decanediamine and mixtures hereof, are particularly preferred.

A further preferred embodiment of the present invention provides that the cycloaliphatic diamine (W) is selected from the group consisting of bis(4-amino-3-methylcyclohexyl) methane (MACM), bis(4-aminocyclohexyl)methane (PACM), bis(4-amino-3-ethylcyclohexyl)methane, bis(4-amino-3,5-dimethylcyclohexyl)methane (TMDC), 2,6-norbornanediamine (2,6-bis(aminomethyl)norbornane), 1,3-diaminocyclohexane (BAC), 1,4-diaminocyclohexanediamine, isophoronediamine, 1,3-bis(aminomethyl)cyclohexane, 1,4-bis(aminomethyl)cyclohexane, 2,2-(4,4′-diaminodicyclohexyl)propane and mixtures hereof. For particular preference, the cycloaliphatic diamines (W) are selected from the group consisting of bis(4-amino-3-methylcyclohexyl)methane (MACM) and bis(4-aminocyclohexyl)methane (PACM) and mixtures hereof.

The aliphatic dicarboxylic acid (X) is an acyclic, aliphatic dicarboxylic acid with 9 to 18 carbon atoms, at least one acyclic, aliphatic dicarboxylic acid with 16 carbon atoms (X1) constituting at least 50% by mol, preferably at least 80% by mol and particularly preferably 100% by mol of all the dicarboxylic acids (X).

A further preferred embodiment of the present invention provides that, in addition to the acyclic, aliphatic dicarboxylic acid with 16 carbon atoms (X1), optionally additionally present aliphatic dicarboxylic acids (X2) are selected from the group consisting of 1,9-nonanedioic acid, 1,10-decanedioic acid, 1,11-undecanedioic acid, 1,12-dodecanedioic acid, 1,13-tridecanedioic acid, 1,14-tetradecanedioic acid, 1,15-pentadecanedioic acid, 1,17-heptadecanedioic acid, 1,18-octadecanedioic acid and mixtures hereof. For particular preference, the open-chain, aliphatic dicarboxylic acids (X2) are selected from the group consisting of dicarboxylic acids with 10 to 15 carbon atoms, in particular 1,10-decanedioic acid, 1,12-dodecanedioic acid, 1,14-tetradecanedioic acid, 1,15-pentadecanedioic acid and mixtures hereof. The dicarboxylic acids (X) consist of up to at least 50% by mol, preferably up to at least 80% by mol of (X1) and particularly preferably up to 100%, i.e. exclusively, of dicarboxylic acid (X1). Complementarily thereto, the dicarboxylic acids (X) consist at most up to 50% by mol, preferably at most up to 20% by mol of dicarboxylic acids (X2) and particularly preferably they are free of dicarboxylic acids (X2). Dicarboxylic acid (X) is particularly preferably exclusively 1,16-hexadecanedioic acid (X1).

According to a further preferred embodiment of the present invention, the aromatic dicarboxylic acid (Y) is selected from the group consisting of terephthalic acid, isophthalic acid, naphthalenedicarboxylic acids (NDA), in particular 1,5-naphthalenedicarboxylic acid and 2,6-naphthalenedicarboxylic acid, biphenyldicarboxylic acids, in particular biphenyl-2,2′-dicarboxylic acid, 4,4′-diphenyldicarboxylic acid, 3,3′-diphenyldicarboxylic acid, 4,4′-diphenyletherdicarboxylic acid, 4,4′-diphenylmethanedicarboxlic acid and 4,4′-diphenylsulphonedicarboxylic acid, 1,5-anthracenedicarboxylic acid, p-terphenylene-4,4″-dicarboxylic acid and 2,5-pyridinedicarboxylic acid and mixtures thereof. For particular preference, the aromatic dicarboxylic acids (Y) are selected from the group consisting of terephthalic acid, isophthalic acid and mixtures hereof.

According to a further preferred embodiment of the present invention, the lactam and/or the α,ω-aminocarboxylic acid (Z) is selected from the group consisting of caprolactam (CL), α,ω-aminocaproic acid, α,ω-aminoheptanoic acid, α,ω-aminoctanoic acid, α,ω-aminononanoic acid, α,ω-aminodecanoic acid, α,ω-aminoundecanoic acid (AUA), laurinlactam (LL) and α,ω-aminododecanoic acid (ADA), laurinlactam, α,ω-aminoundecanoic acid and α,ω-aminododecanoic acid and mixtures thereof are particularly preferred.

In the case of component (A2) according to formula VX/WX/VY/WY/Z, it is particularly preferred that (V) is selected from the group consisting of 1,6-hexanediamine, 1,9-nonanediamine, 1,10-decanediamine, (W) from the group bis(4-amino-3-methylcyclohexyl)methane (MACM) and bis(4-aminocyclohexyl)methane (PACM), (X) is selected as 1,16-hexadecanedioic acid, (Y) from the group terephthalic acid, isophthalic acid and (Z) from the group laurinlactam, α,ω-aminoundecanoic and α,ω-aminododecanoic acid.

With respect to the properties and processibility, it proves advantageous if the transparent polyamide (A2) has a solution viscosity (ηᵣₑₗ, determined on a solution of 0.5 g polymer granulate in 100 ml m-cresol at 20° C. according to ISO 307:2013) between 1.4 und 2.2, particularly preferably between 1.50 und 2.0 and in particular in the range of 1.60 to 1.90, and/or has a glass transition temperature T_{g} above 90° C., preferably above 100° C., further preferably above 110° C., particularly preferably above 130° C. Likewise, it proves advantageous if the transparent polyamide (A2) is an amorphous polyamide with a melting enthalpy of less than 4 J/g or a microcrystalline polyamide with a melting enthalpy in the range of 4-30 J/g, in particular in the range of 4-25 J/g.

MACM thereby stands for the ISO designation bis(4-amino-3-methylcycloexyl)methane, which is commercially available under the trade name 3,3′-dimethyl-4-4′-diaminodicyclohexylmethane as Laromin C260-Type (CAS no. 6864-37-5). The number according to the term MACM stands respectively for an aliphatic dicarboxylic acid (C12 e.g. DDS, dodecanedioic acid), with which the diamine MACM is polycondensed. PACM stands for the ISO designation bis(4-aminocyclohexyl)methane, which is commercially available under the trade name 4,4′-bisaminodidyclohexymethane as Dicykan-Type (CAS no. 1761-71-3).

Preferably component (A2) concerns MACM16, PACM16, MACM16/PACM16, MACMI/MACMT/MACM16 or 6I/6T/616/MACMI/MACMT/MACM16 or a mixture of two or more of these systems.

Particularly preferred transparent polyamides are: MACM 16, MACM16/PACM16, MACMI/MACMT/MACM16 or 6I/6T/616/MACMI/MACMT/MACM16.

Component (A3)

Optionally the moulding compound can comprise furthermore, as component (A3), at least one long-chain, aliphatic polyamide selected from the group consisting of polyamide 11, polyamide 12 and polyamides PA10U, (U) standing for amidically bonded, acyclic aliphatic dicarboxylic acids with 10 to 18 carbon atoms. In particular, component (A3) is selected from the group consisting of polyamides consisting of PA1010, PA1012, PA1014, PA1212, PA1214, PA1016 or a mixture thereof. Polyamide 1016 is particularly preferred.

Component (A3) is preferably formed by polycondensation/polymerisation of the aliphatic diamines 1,10-decanediamine and/or 1,12-dodecanediamine and also the aliphatic dicarboxylic acids 1,10-decanedioic acid, 1,11-undecanedioic acid, 1,12-dodecanedioic acid, 1,13-tridecanedioic acid, 1,14-tetradecanedioic acid, 1,15-pentadecanedioic acid, 1,16-hexadecanedioic acid, 1,17-heptadecanedioic acid 1,18-octadecanedioic acid or lactams or aminodicarboxylic acids α,ω-aminodecanoic acid, α,ω-aminoundecanoic acid (AUA), laurinlactam (LL) and α,ω-aminododecanoic acid (ADA).

With respect to the processibility and the properties of the produced objects, it proves advantageous if the aliphatic polyamide of component (A3), in particular if this is selected as PA12, PA1010 and PA1016, has a solution viscosity (determined on a solution of 0.5 g polymer granulate in 100 ml m-cresol at 20° C. according to ISO 307:2013) in the range of ηᵣₑₗ=1.5 to 3.0, preferably in the range of ηᵣₑₗ=1.6 to 2.6, in particular in the range of 1.70 to 2.30.

In a preferred embodiment, the sum of components (A2) and (A3) is 5 to 50% by weight, preferably 10 to 40% by weight and in particular 15-35% by weight.

Component (B)

Component (B) can include both fibrous reinforcing means and further particulate fillers. It is particularly preferred if (B) consists exclusively of fibrous reinforcing means, selected from the group: glass fibres, carbon fibres, boron fibres, aramide fibres, basalt fibres and respectively mixtures thereof.

According to a preferred embodiment of the polyamide moulding compound according to the invention, component (B) is formed completely of glass fibres.

The glass fibres used have a cross-sectional area which is either circular (or synonymously round) or non-circular (or synonymously flat), in the latter case the dimensioning ratio of the main cross-sectional axis to the subsidiary cross-sectional axis being at least 2, e.g. of 2.5 to 4.5.

Reinforcement with glass fibres can be effected with short fibres (e.g. cut glass with a length of 2-50 mm) or endless fibres (long glass or rovings).

The glass fibres used according to the invention as roving (filler component B) have a diameter of 10 to 20 μm, preferably of 12 to 17 μm. There should be understood, furthermore, by the generally used term diameter, in the case of fibres with a non-circular, i.e. an anisotropic, cross-section, i.e. with a longer main cross-sectional axis than subsidiary cross-sectional axis, the length of the main cross-sectional axis. In particular E-glass fibres are used according to the invention. However also all other types of glass fibre, such as e.g. A-, C-, D-, M-, S-, R-glass fibres or any mixtures thereof or mixtures with E-glass fibres, can be used.

In the case of long fibre-reinforced moulding compounds, higher strengths and hence also more metal-like properties are produced if, instead of the normal endless glass fibre with a diameter of 15 to 19 μm, those with a diameter of 10 to 14 μm, in particular those with a diameter of 10 to 12 μm, are used.

In a preferred embodiment, the glass fibres used according to the invention are short glass fibres with a diameter in the range of 7 to 20, preferably 9 to 12 μm. The glass fibres are present in the form of cut glass with a length of 2 to 50 mm. In particular, E- and/or S-glass fibres are used according to the invention. However, also all other types of glass fibre, such as e.g. A-, C-, D-, M-, R-glass fibres or any mixtures thereof or mixtures with E- and/or S-glass fibres, can be used. The sizings which are normal for polyamide, such as e.g. various aminosilane sizings, are used, high-temperature-stable sizings being preferred.

In a further preferred embodiment the glass fibres used are long glass fibres. The glass fibres used according to the invention as roving have a diameter of 10 to 20 μm, preferably of 12 to 17 μm. In particular E-glass fibres are used according to the invention. In addition to the preferred E-glass fibres, in particular S-glass fibres are used since, relative to E-glass fibres, they have a tensile strength which is higher by 30%. However, also all other types of glass fibre, such as e.g. A-, C-, D-, M-, R-glass fibres or any mixtures thereof or mixtures with E- and/or S-glass fibres, can be used.

In the case of flat glass fibres, i.e. glass fibres with a non-circular cross-sectional area, those with a dimensional ratio of the main cross-sectional axis to the subsidiary cross-sectional axis, which is perpendicular thereto, of more than 2, preferably of 2.5 to 4.5, in particular of 3 to 4, are used preferably. These so-called flat glass fibres have an oval, elliptical, elliptical provided with a constriction(s) (so-called cocoon fibre), polygonal, rectangular or almost rectangular cross-sectional area. A further characterising feature of the flat glass fibres used resides in the fact that the length of the main cross-sectional axis is preferably in the range of 6 to 40 μm, in particular in the range of 15 to 30 μm and the length of the subsidiary cross-sectional axis is in the range of 3 to 20 μm, in particular in the range of 4 to 10 μm. The flat glass fibres thereby have as high a packing density as possible, i.e. the glass cross-sectional area fills an imaginary rectangle surrounding the glass fibre cross-section as exactly as possible up to at least 70%, preferably at least 80% and particularly preferably up to at least 85%.

For reinforcement of the moulding compounds according to the invention, also mixtures of glass fibres with a circular and non-circular cross-section can be used, the proportion of flat glass fibres preferably predominating, i.e. constituting more than 50% by weight of the total mass of the fibres.

The glass fibres according to the invention can be provided with a sizing suitable for thermoplastics, in particular for polyamide, comprising an adhesive based on an amino- or epoxysilane compound.

The flat glass fibres of component (B1) are thereby selected e.g. preferably as E-glass fibres according to ASTM D578-00 with a non-circular cross-section, preferably made of 52-62% silicon dioxide, 12-16% aluminium oxide, 16-25% calcium oxide, 0-10% borax, 0-5% magnesium oxide, 0-2% alkali oxide, 0-1.5% titanium dioxide and 0-0.3% iron oxide (details respectively in % by weight). The glass fibres of component (B1) preferably have, as flat E-glass fibres, a density of 2.54-2.62 g/cm³, a modulus of elasticity in tension of 70-75 GPa, a tensile strength of 3,000-3,500 MPa and a tearing elongation of 4.5-4.8%, the mechanical properties being determined on individual fibres with a diameter of 10 μm and a length of 12.7 mm at 23° C. and a relative air humidity of 50%.

A preferred embodiment of the polyamide moulding compound according to the invention is distinguished by component (B) being present in the range of 10-55% by weight, preferably in the range of 20-50% by weight, further preferably of 30 to 50% by weight, particularly preferably in the form of glass fibres.

Component (B) can furthermore comprises fillers, likewise in surface-treated form, selected from the following group: talc, mica, silicate, quartz, titanium dioxide, wollastonite, kaolin, amorphous silicic acids, magnesium carbonate, magnesium hydroxide, chalk, lime, feldspar, barium sulphate, solid or hollow glass balls or ground glass, in particular ground glass fibres, permanently magnetic or magnetisable metal compounds and/or alloys and also mixtures of the elements from this group. There are particularly preferred as filler, microglass balls with an average diameter in the range of 5 to 100 μm, since these tend to endow the moulded article with isotropic properties and hence allow the production of moulded articles with low distortion.

As filler, the thermoplastic moulding compounds according to the invention can preferably therefore comprise a particulate filler or a mixture of two of more different fillers, also in combination with reinforcing materials.

Component C

The polyamide moulding compound according to the invention comprises 0 to 3% by weight of at least one additive (auxiliary materials and/or additives) as component (C).

According to a preferred embodiment, the polyamide moulding compound according to the invention comprises 0.1 to 3.0% by weight and preferably 0.5 to 2.0% by weight, of at least one additive as component (C).

According to a preferred embodiment, component (C) is selected from the group consisting of lubricants, heat stabilisers, processing stabilisers, oxidation retardants, means to counter heat decomposition and decomposition by ultraviolet light, lubricants and mould-release means, colourants, in particular dyes and pigments, nucleation agents, plasticisers, flame retardants, inorganic pigments, organic pigments and mixtures thereof.

According to a particularly preferred embodiment, the polyamide moulding compound comprises, as component (C), at least one lubricant, this being contained preferably in a proportion of 0 to 2% by weight, particularly preferably of 0.05 to 2.0% by weight, particularly preferably of 0.1 to 1.5% by weight and most preferably of 0.1 to 1.0% by weight, respectively relative to the total weight of the polyamide moulding compound.

Al-, alkali-, alkaline earth salts, esters or amides of fatty acids with 10 to 44 C atoms, and preferably with 14 to 44 C atoms, are hereby preferred, metal ions Na, Mg, Ca and Al being preferred and Ca or Mg being particularly preferred. Particularly preferred metal salts are Ca stearate and Ca montanate and also Al stearate. The fatty acids can be 1- or 2-valent. As examples, there may be mentioned pelargonic acid, palmitic acid, lauric acid, margaric acid, dodecanedioic acid, behenic acid and the particularly preferred stearic acid, capric acid and also montanic acid (mixtures of fatty acids with 30 bis 40 C atoms).

Furthermore, aliphatic alcohols, which can be 1- or 4-valent, are preferred as lubricant. Preferably these alcohols are selected from the group consisting of n-butanol, n-octanol, stearyl alcohol, ethylene glycol, propylene glycol, neopentyl glycol, glycerol, pentaerythritol and mixtures thereof, glycerol and pentaerythritol being preferred.

In addition, aliphatic amines, which can be 1- to 3-valent, are preferred lubricants. Preferred amines are selected from the group consisting of stearylamine, ethylenediamine, propylenediamine, hexamethylenediamine, di(6-aminohexyl)amine and mixtures hereof, ethylenediamine and hexamethylenediamine being particularly preferred.

Preferred esters or amides of fatty acids are selected from the group consisting of glyceryl distearate, glyceryl tristearate, ethylenediaminedistearate, glyceryl monopalmitate, glyceryltrilaurate, glyceryl monobehenate, pentaerythritoltetrastearate and mixtures hereof.

According to a further preferred embodiment, the polyamide moulding compound as component (C) comprises at least one heat stabiliser, this being preferably contained in a proportion of 0 to 3% by weight, particularly preferably of 0.02 to 2.0% by weight and particularly preferably of 0.1 to 1.5% by weight, respectively relative to the total weight of polyamide moulding compound (1).

According to a preferred embodiment, the heat stabilisers are selected from the group consisting of
compounds of mono- or bivalent copper, e.g. salts of mono- or bivalent copper with inorganic or inorganic acids or mono- or bivalent phenols, the oxides of mono- or bivalent copper, or the complex compounds of copper salts with ammonia, amines, amides, lactams, cyanides or phosphines, preferably Cu(I)- or Cu(II)-salts of hydrohalic acids, hydrocyanic acids or the copper salts of aliphatic carboxylic acids. Particularly preferred are the monovalent copper compounds CuCl, CuBr, CuI, CuCN and Cu₂O, and also the bivalent copper compounds CuCl₂, CuSO₄, CuO, copper(II)acetate or copper(II)stearate. If a copper compound is used, the quantity of copper is preferably 0.003 to 0.5, in particular 0.005 to 0.3 and particularly preferably 0.01 to 0.2% by weight, relative to the sum of components (A) to (C).
The copper compounds are commercially available or their production is known to the person skilled in the art. The copper compounds can be used as such or in the form of concentrates. There should thereby be understood by concentrate a polymer, preferably of equal chemical nature to component (A), which comprises the copper salt in high concentration. The use of concentrates is a normal method and is applied particularly frequently when very small quantities of the substance of use are to be metered. Advantageously, the copper compounds are used in combination with further metal halogenides, in particular alkali halogenides, such as NaI, KI, NaBr, KBr, the molar ratio of metal halogenide to copper halogenide being 0.5 to 20, preferably 1 to 10 and particularly preferably 3 to 7.
stabilisers based on secondary aromatic amines, these stabilisers being present preferably in a quantity of 0.2 to 2, preferably of 0.2 to 1.5% by weight,
stabilisers based on sterically hindered phenols, these stabilisers being present preferably in a quantity of 0.1 to 1.5, preferably of 0.2 to 1.0% by weight, and
phosphites and phosphonites, and also
mixtures of the above-mentioned stabilisers.

Particularly preferred examples of useable stabilisers according to the invention based on secondary aromatic amines are adducts of phenylenediamine with acetone (Naugard A), adducts of phenylenediamine with linolen, Naugard 445, N,N′-dinaphthyl-p-phenylenediamine, N-phenyl-N′-cyclohexyl-p-phenylenediamine or mixtures of two or more thereof.

As sterically hindered phenols, in principal all compounds with phenolic structure, which have at least one sterically suitable group on the phenol ring, are suitable. Preferred examples of useable stabilisers according to the invention, based on sterically hindered phenols are N,N′-hexamethylene-bis-3-(3,5-di-tert-butyl-4-hydroxyphenyl)propionamide, bis(3,3-bis(4′-hydroxy-3′-tert-butylphenyl)butanoic acid)glycol ester, 2,1′-thioethylbis(3-(3,5-di.tert-butyl-4-hydroxyphenyl)propionate, 4-4′-butylidene-bis(3-methyl-6-tert.-butylphenol), triethyleneglycol-3-(3-tert-butyl-4-hydroxy-5-methylphenyl)propionate or mixtures of two or more of these stabilisers.

Preferred phosphites and phosphonites are triphenylphosphite, diphenylalkylphosphite, phenyldialkylphosphite, tris(nonylphenyl)phosphite, trilaurylphosphite, trioctadecylphosphite, distearylpentaerythritoldiphosphite, tris(2,4-di-tert-butylphenyl)phosphite, diisodecylpentaerythritoldiphosphite, bis(2,4-di-tert-butylphenyl)pentaerythritoldiphosphite, bis(2,6-di-tert-butyl-4-methylphenyl)pentaerythritoldiphosphite, diisodecyloxypentaerythritoldiphosphite, bis(2,4-di-tert-butyl-6-methylphenyl)pentaerythritoldiphosphite, bis(2,4,6-tris-(tert-butylphenyl))pentaerythritoldiphosphite, tristearylsorbitoltriphosphite, tetrakis(2,4-di-tert-butylphenyl)-4,4′-biphenylenediphosphonite, 6-isooctyloxy-2,4,8,10-tetra-tert-butyl-12H-dibenz-[d,g]-1,3,2-dioxaphosphocine, 6-fluoro-2,4,8,10-tetra-tert-butyl-12-methyldibenz[d,g]-1,3,2-dioxaphosphocine, bis(2,4-di-tert-butyl-6-methylphenyl)methylphosphite and bis(2,4-di-tert-butyl-6-methylphenyl)ethylphosphite. In particular, there are preferred tris[2-tert-butyl-4-thio(2′-methyl-4′-hydroxy-5′-tert-butyl)phenyl-5-methyl]phenylphosphite and tris(2,4-di-tert-butylphenyl)phosphite (Hostanox® PAR24: commercial product of the company Clariant, Basle).

A preferred embodiment of the heat stabiliser consists of the combination of organic heat stabilisers (in particular Hostanox PAR 24 and Irganox 1010), a bisphenol A-based epoxide (in particular Epikote 1001) and a copper stabilisation based on CuI and KI. A commercially available stabiliser mixture, consisting of organic stabilisers and epoxides is for example Irgatec NC66 of Ciba Spez. GmbH. A heat stabilisation based exclusively on CuI and KI is particularly preferred.

Furthermore, the polyamide moulding compound according to the invention as component (C) can comprise normal processing aids, such as stabilisers, oxidation retardants, further means to counter heat decomposition and decomposition by ultraviolet light, lubricant and mould-release means, colourants, such as dyes and pigments, nucleation agents, flame retardants etc.

As examples of oxidation retardants and heat stabilisers, there may be mentioned phosphites and further amines (e.g. TAD), hydroquinone, different substituted representatives of these groups and mixtures thereof in concentrations up to 1% by weight, relative to the total weight of the polyamide moulding compound (I).

As UV stabilisers, which in general are used in quantities up to 2% by weight, relative to the weight of the polyamide moulding compound, various substituted resorcins, salicylates, benzotriazoles and benzophenones may be mentioned.

Inorganic pigments, such as titanium dioxide, ultramarine blue, iron oxide and carbon black and/or graphite, furthermore organic pigments, such as phthalocyanines, quinacridones, perylenes, and also colourants such as nigrosine and anthraquinones can be used as colourant.

As nucleation agent, sodium phenylphosphinate, kaolin, talc, aluminium oxide, aluminosilicate, silicon dioxide and also preferably talcum can be used.

The present invention relates in addition to a moulding compound as is used in the previously described use. All of the preferred embodiments of the moulding compound described above within the scope of the illustrated use of the moulding compound likewise apply for the moulding compound according to the invention.

In a preferred embodiment, the moulding compound according to the invention for reducing solid material deposits and/or coatings is based on a polyamide moulding compound consisting of the following components:
(A) 77-100% by weight, e.g. 77-99.9% by weight, of a polyamide mixture consisting of components (A1), (A2) and (A3),
   (A1) 50-95, preferably 60-90% by weight, of at least one aliphatic polyamide selected from homopolyamides 616, 516 or 916, and also copolyamides 516/616, 516/916, 616/1016, 616/610, 616/612 or 616/614 and mixtures thereof, the proportion of 616, 516 or 916 in the copolyamides constituting at least 50% by mol, preferably at least 60% by mol and in particular 80% by mol; and
   (A2) 0-50% by weight of at least one transparent polyamide VX/WX/VY/WY/Z, at least one of the polyamide units WX or WY being present and the abbreviations V to Z being derived from the following molecules: V: 1,6-hexanediamine, 1,10-decanediamine; W: MACM, PACM, TMDC; X: 1,16-hexadecanedioic acid; Y: terephthalic acid, isophthalic acid; Z: laurinlactam, α,ω-aminoundecanoic acid and α,ω-aminododecanoic acid;
   (A3) 0-50% by weight of at least one aliphatic polyamide selected from the group consisting of PA11, PA12, PA1010, PA1012, PA1014, PA1212, PA1214 and PA1016;
      the sum of (A1) to (A3) producing the totality of component (A) and the sum of (A2) and (A3) being 5 to 50, preferably 10 to 40% by weight;
(B) 0-20% by weight of fillers and/or reinforcing materials;
(C) 0-3% by weight, e.g. 0.1-3% by weight, of aids and/or additives the sum of components (A) to (C) constituting 100% by weight.

This special moulding compound is suitable in particular for extrusion applications.

In a further preferred embodiment, the moulding compound according to the invention for reducing solid material deposits and/or coatings is based on a polyamide moulding compound consisting of the following components:
(A) 37-80, preferably 47-80% by weight, of a polyamide mixture consisting of components (A1), (A2) and (A3),
   (A1) 50-95, preferably 60-90% by weight, of at least one aliphatic polyamide selected from homopolyamides 616, 516 or 916, and also copolyamides 516/616, 516/916, 616/1016, 616/610, 616/612 or 616/614 and mixtures thereof, the proportion of 616, 516 or 916 in the copolyamides constituting at least 50% by mol, preferably at least 60% by mol and in particular 80% by mol; and
   (A2) 0-50% by weight of at least one transparent polyamide VX/WX/VY/WY/Z, at least one of the polyamide units WX or WY being present and the abbreviations V to Z being derived from the following molecules: V: 1,6-hexanediamine, 1,10-decanediamine; W: MACM, PACM, TMDC; X: 1,16-hexadecanedioic acid; Y: terephthalic acid, isophthalic acid; Z: laurinlactam, α,ω-aminoundecanoic acid and α,ω-aminododecanoic acid;
   (A3) 0-50% by weight of at least one aliphatic polyamide selected from the group consisting of PA11, PA12, PA1010, PA1012, PA1014, PA1212, PA1214 and PA1016;

the sum of (A1) to (A3) producing the totality of component (A) and the sum of (A2) and (A3) being 5 to 50, preferably 10 to 40% by weight;
(B) 20-60, preferably 20-50% by weight, of fillers and/or reinforcing materials;
(C) 0-3% by weight of aids and/or additives
   the sum of components (A) to (C) constituting 100% by weight.

This special moulding compound is suitable in particular for injection moulding applications.

Furthermore, the present invention relates to a method for the production of everyday articles by means of thermoplastic reshaping in discontinuous processes, in particular in injection moulding, and in continuous processes, such as extrusion to form films, fibres, pipes and coverings in which a moulding compound is used as in the previously described use.

Both for the moulding compound according to the invention and the method according to the invention, the same preferred embodiments as were described above for the use apply with respect to the moulding compound.

### WAYS TO IMPLEMENT THE INVENTION

The subsequently mentioned materials were used in the examples according to table 1:
PA Type A: polyamide 616 (ηᵣₑₗ=2.14), EMS-CHEMIE AG, Switzerland
PA Type B: polyamide 12 (ηᵣₑₗ=1.96), EMS-CHEMIE AG, Switzerland
PA Type C: polyamide MACM16 with ηᵣₑₗ=1.72, EMS-CHEMIE AG, Switzerland
PA Type D: polyamide MACM16/PACM16 with ηᵣₑₗ=1.70, EMS-CHEMIE AG, Switzerland
PA Type E: polyamide MACM12 with ηᵣₑₗ=1.82, EMS-CHEMIE AG, Switzerland
Irganox 1010: pentaerythritoltetrakis[3-(3,5-di-tert-butyl-4-hydroxyphenyl)propionate, antioxidant based on a sterically hindered phenol
Glass fibres Type A: CS 7928, 4.5 mm long, 10 μm diameter, BAYER AG, Germany
Glass fibres Type B: CSG3PA-820, 3 mm long, 28 μm wide, 7 μm thick, aspect ratio of the cross-sectional axes=4, (flat glass fibres)

The moulding compounds of the compositions in table 1 and table 2 were produced on a twin-screw extruder of the company Werner and Pfleiderer type ZSK 30. The granulates of type A to D and also the stabilisation were metered into the feed zone. The glass fibre was metered into the polymer melt via a side feeder 3 housing units in front of the nozzle.

The housing temperature was set as rising profile of 220 to 280° C. At 150 to 200 rpm, 10 kg throughput was achieved. Granulation was effected by means of an underwater granulation or hot cut die-face underwater in which the polymer melt is pressed through a perforated nozzle and, directly after leaving the nozzle, is granulated by a rotating blade in a water flow. After granulation and drying at 100° C. for 24 h, the granulate properties were measured and the test pieces produced.

The test pieces for determining the mechanical characteristic values of the unreinforced and reinforced moulding compounds were produced on an Arburg injection moulding machine, the cylinder temperatures of 230° C. to 270° C. and a screw circumferential speed of 15 m/min being set. The mould temperature was chosen at 80° C.

The measurements were implemented according to the following standards and on the following test pieces.

Modulus of Elasticity in Tension

ISO 527:2012 at a tensile speed of 1 mm/min, ISO test bar, standard: ISO/CD 3167 (DIN EN ISO 3167:2014), type A1, 170×20/10×4 mm, temperature 23° C.

Breaking Strength and Breaking Elongation:

ISO 527:2012 at a tensile speed of 5 mm/min for reinforced moulding compounds and at a tensile speed of 50 mm/min for unreinforced moulding compounds. ISO test bar, standard: ISO/CD 3167 (DIN EN ISO 3167:2014), type A1, 170×20/10×4 mm, temperature 23° C.

Impact Strength According to Charpy:

ISO 179/*eU (DIN EN ISO 3167:2014), ISO test bar, standard: ISO/CD 3167 (DIN EN ISO 3167:2014), type B1, 80×10×4 mm, temperature 23° C., * 1=not instrumented, 2=instrumented

Notch Impact Strength According to Charpy:

ISO 179/*eA (DIN EN ISO 3167:2014), ISO test bar, standard: ISO/CD 3167 (DIN EN ISO 3167:2014), type B1, 80×10×4 mm, temperature 23° C., * 1=not instrumented, 2=instrumented

Glass Transition Temperature (Tg), Melting Point (Tm) and Melting Enthalpy (ΔHm):

ISO-standard 11357 (−1, −2, −3):2013, granulate.

Differential Scanning Calorimetry (DSC) was implemented at a heating rate of 20° C./min.

Relative Viscosity:

DIN EN ISO 307:2013, determined on a solution of 0.5 g polymer granulate in 100 ml m-cresol, temperature 20° C.

If nothing different is noted in the table, the test pieces are used in the dry state. For this purpose, the test pieces are stored, after injection moulding, for at least 48 h at room temperature in a dry environment.
Extrusion of corrugated pipes: examples E1 to E5 (according to the invention) and also comparative examples CE1, CE2, CE8 and CE10

For examination of the effect of the polyamide moulding compounds on the production of corrugated pipes, the compounds according to table 1 were produced and processed to form corrugated pipes in an endurance test. The material was extruded at 250° C. (Müller & Sohn AG, Rorbas) and at a withdrawal speed of 2 m/min and a mould jaw temperature of 50° C. to form corrugated pipes (Uniwell Corrugator). With the compounds according to the invention, after 10 h only very few (assessment “+” or even no deposits (assessment “++”) were shown on the vacuum slots, whilst in the case of the PA12-based moulding compounds of the comparative tests, in fact a significant coating was formed after 2 or 3 hours which clogged the vacuum slots after 3 or 6 hours.

TABLE 1
Properties of non-reinforced moulding compounds, corrugated
tube production and film production, CE = comparative example
not according to the invention, E = example according to the
invention

| Components | Unit | CE1 | CE2 | CE8 | CE10 | E1 | E2 | E3 | E4 | E5 |
|---|---|---|---|---|---|---|---|---|---|---|
| PA Type A | % by weight | | | | 59.5 | 99.5 | 84.5 | 59.5 | 79.5 | 69.5 |
| PA Type B | % by weight | 99.5 | 84.5 | 59.5 | | | | | 20.0 | 20.0 |
| PA Type C | % by weight | | 15.0 | | | | 15.0 | | | |
| PA Type D | % by weight | | | | | | | 40.0 | | 10.0 |
| PA Type E | % by weight | | | 40.0 | 40.0 | | | | | |
| IRGANOX 1010 | % by weight | 0.5 | 0.5 | 0.5 | 0.5 | 0.5 | 0.5 | 0.5 | 0.5 | 0.5 |

Properties

| Tm | ° C. | 178 | 178 | 177 | 193 | 197 | 196 | 194 | 197 | 195 |
|---|---|---|---|---|---|---|---|---|---|---|
| Water absorption | % | 0.7 | 0.7 | 0.6 | 0.6 | 0.8 | 0.8 | 0.5 | 0.8 | 0.7 |
| 23° C./50% RH | | | | | | | | | | |
| Modulus of | MPa | 1,300 | 1,400 | 1,510 | 1,570 | 1,440 | 1,480 | 1,560 | 1,380 | 1,380 |
| elasticity in tension | | | | | | | | | | |
| Breaking strength | MPa | 50 | 54 | 56 | 50 | 55 | 52 | 58 | 53 | 52 |
| Breaking elongation | % | 275 | 220 | 210 | 170 | 280 | 220 | 260 | 280 | 250 |
| Impact strength | kJ/m² | neg. | neg. | neg | 70 | neg. | neg. | neg. | neg. | neg. |
| Charpy, 23° C. | | | | | | | | | | |
| Notch impact | kJ/m² | 7 | 7 | 8 | 5 | 8 | 8 | 10 | 8 | 8 |
| strength | | | | | | | | | | |
| Charpy, 23° C. | | | | | | | | | | |
| Coating formation | | −− | − | − | + | + | ++ | ++ | + | ++ |
| corrugated pipes | | | | | | | | | | |
| Test number | | | | | | | | | | |
| Flat films | | CE3 | CE4 | CE9 | CE11 | E6 | E7 | E8 | E9 | E10 |
| Coating formation | | −− | − | − | + | + | ++ | ++ | + | ++ |
| flat films | | | | | | | | | | |

Extrusion of films on a cooled roller: examples E6 to E10 (according to the invention) and also comparative examples CE3, CE4, CE9 and CE11

On a twin-screw extruder ZK 25 T of the company Collin, Ebersberg, the compositions according to table 1 were melted and withdrawn as film, the coating formation being observed within a time period of 90 minutes. The diameter of the two co-rotating screws was 25 mm and the length/diameter ratio L/D=8/1. The granulate was metered via a gravimetric meter K-Tron K-SFS-24 with screw conveyance and was melted by five heating zones at 100, 230, 240, 240 and 240° C. The melt was discharged through a horizontal wide slot nozzle (120 mm). The speed of rotation was 150 rpm with a throughput of 3 kg/h. The film was withdrawn, smoothed and wound up by a flat film unit Collin Chill Roll type CR 72 T. The first two rollers were temperature-controlled (20° C.) and closed. Subsequently, the film ran over a cooling roller and was wound up. During extrusion of the moulding compounds based on PA12, there was formed within a few minutes (10 min with CE3 (assessment “−−”) and 18 min with CE4 (assessment “−”)), solid deposits on the upper temperature-controlled roller which detached from the roller from time to time and remained suspended on the film. With the compositions according to the invention, a slight coating formation was visible only after 60 minutes (assessment “+”) or was not observed within a 90 minute test duration (assessment “++”).
Injection moulding: examples E11 to E14 (according to the invention) and comparative examples CE5 to CE7, CE12 and CE13:

On an injection moulding unit Krauss Maffei KM 50-55C, tests were implemented for coating formation during processing of the compositions indicated in table 2. There was used as mould, a module for weld line test bars which had a nitrated venting insert with 0.01 mm venting depth. The moulding compounds were melted (cylinder temperatures rising from 230-270° C.) and were produced with an injection speed of 100 mm/s to form test bars (table 2). At the venting opening of the mould, there could be recognised, with PA12-based moulding compounds (CE5 to CE7, CE13), a coating formation even after 10-20 cycles (assessment “−”), whilst the moulding compounds E11 to E14 according to the invention formed no coating even after 100 processing cycles (assessment “+”) or after 200 processing cycles (assessment “++”).

TABLE 2
Properties of reinforced moulding compounds, injection moulding
processing, CE = comparative example, not according to the invention,
E = example according to the invention

| Components | Unit | CE5 | CE6 | CE7 | CE12 | CE13 | E11 | E12 | E13 | E14 |
|---|---|---|---|---|---|---|---|---|---|---|
| PA Type A | % by weight | | | | 29.5 | | 49.5 | 34.5 | 29.5 | 39.5 |
| PA Type B | % by weight | 49.5 | 34.5 | 39.5 | | 29.5 | | | | 10.0 |
| PA Type C | % by weight | | 15.0 | | | | | 15.0 | | |
| PA Type D | % by weight | | | 10.0 | | | | | 20.0 | |
| PA Type E | % by weight | | | | 20.0 | 20.0 | | | | |
| IRGANOX 1010 | % by weight | 0.5 | 0.5 | 0.5 | 0.5 | 0.5 | 0.5 | 0.5 | 0.5 | 0.5 |
| Glass fibre Type | % by weight | 50 | 50 | 50 | | | 50 | 50 | | |
| A | | | | | | | | | | |
| Glass fibre Type | % by weight | | | | 50 | 50 | | | 50 | 50 |
| B | | | | | | | | | | |

Properties

| | | | | | | | | | | |
|---|---|---|---|---|---|---|---|---|---|---|
| MVR | ccm/10 min | | | | | | | | | |
| Tm | ° C. | | | | | | | | | |
| Modulus of | MPa | 11720 | 12000 | 11900 | 12000 | 11940 | 11840 | 11950 | 11880 | 11700 |
| elasticity in | | | | | | | | | | |
| tension | | | | | | | | | | |
| Breaking | MPa | 149 | 157 | 154 | 148 | 155 | 152 | 154 | 156 | 151 |
| strength | | | | | | | | | | |
| Breaking | % | 4.7 | 3.3 | 3.9 | 2.6 | 3.3 | 5.1 | 4.8 | 5.0 | 5.2 |
| elongation | | | | | | | | | | |
| Impact strength | kJ/m² | 80 | 85 | 89 | 62 | 87 | 98 | 92 | 96 | 95 |
| Charpy, 23° C. | | | | | | | | | | |
| Notch impact | kJ/m² | 22 | 24 | 25 | 12 | 23 | 26 | 25 | 28 | 25 |
| strength | | | | | | | | | | |
| Charpy, 23° C. | | | | | | | | | | |
| Coating | | − | − | − | + | − | + | ++ | ++ | + |
| formation | | | | | | | | | | |
| injection | | | | | | | | | | |
| moulding | | | | | | | | | | |

1-15. (canceled)

16. A method of reducing the formation of solid material deposits and/or coatings during thermoplastic reshaping to form articles in a continuous or discontinuous process, the method comprising moulding a thermoplastic polyamide moulding compound comprising:
(A) 37-100% by weight of a polyamide mixture consisting of components (A1), (A2) and (A3),
(A1) 50-100% by weight of at least one aliphatic polyamide which comprises at least up to 50% by mol of at least one polyamide unit selected from the group consisting of 616, 916 and 516 or consists hereof; and
(A2) 0-50% by weight of at least one transparent polyamide VX/WX/VY/WY/Z, at least one of the polyamide units WX or WY being present and the abbreviations V to Z being derived from the following molecules: V: acyclic, aliphatic diamine with 6 to 12 carbon atoms; W: cycloaliphatic diamine; X: at least one acyclic, aliphatic dicarboxylic acid with 9 to 18 carbon atoms, at least one acyclic, aliphatic dicarboxylic acid with 16 carbon atoms (X1) constituting at least 50% by mol of all dicarboxylic acids X; Y: aromatic dicarboxylic acids, Z: lactams and aminocarboxylic acids with 6 to 12 carbon atoms;
(A3) 0-50% by weight of at least one aliphatic polyamide selected from the group consisting of PA11, PA12 and P10U with U=amidically bonded acyclic, aliphatic dicarboxylic acid with 10 to 18 carbon atoms;
the sum of (A1) to (A3) producing the totality of component (A);
(B) 0-60% by weight of fillers and/or reinforcing materials; and
(C) 0-3% by weight of aids and/or additives;
the sum of components (A) to (C) constituting 100% by weight.

17. The method according to claim 16, wherein the at least one aliphatic polyamide of component (A1) consists at least up to 60% by mol, of the polyamide units selected from the group consisting of 616, 916 and 516.

18. The method according to claim 16, wherein the at least one aliphatic polyamide of component (A1) consists at least up to 80% by mol, of the polyamide units selected from the group consisting of 616, 916 and 516.

19. The method according to claim 16, wherein the polyamide units, which are present in addition to the polyamide units 616, 916 and/or 516 in component (A1), are polyamide units 6S, 9S, or 10S, wherein S is an acyclic, aliphatic dicarboxylic acid with 9 to 18 carbon atoms.

20. The method according to claim 16, wherein the sum of components (A2) and (A3) is 5 to 50% by weight, relative to the sum of components (A1) to (A3).

21. The method according to claim 20, wherein the sum of components (A2) and (A3) is 10 to 40% by weight, relative to the sum of components (A1) to (A3).

22. The method according to claim 16, wherein component (A1) comprises a homopolyamide selected from the group consisting of PA616, PA916 and PA516, and a copolyamide selected from the group consisting of 516/616, 516/916, 616/1016, 616/610, 616/612, 616/614, and mixtures thereof.

23. The method according to claim 16, wherein component (A1) is based predominantly on monomers which are available from renewable raw materials, and the biocomponent according to ASTM D6866-068a of polyamide (A1) is at least 60% by weight.

24. The method according to claim 16, wherein component (A2) is MACM16, PACM16, MACM16/PACM16, MACMI/MACMT/MACM16, or 6I/6T/616/MACMI/MACMT/MACM16, or a mixture thereof.

25. The method according to claim 16, wherein the reinforcing means of component (B) are selected from the group consisting of glass fibres, carbon fibres, boron fibres, aramide fibres, basalt fibres, mixtures thereof, and/or
the fillers of component (B) are selected from the group consisting of talc, mica, silicate, quartz, titanium dioxide, wollastonite, kaolin, amorphous silicic acids, magnesium carbonate, magnesium hydroxide, chalk, lime, feldspar, barium sulphate, solid or hollow glass balls, and ground glass.

26. The method according to claim 16, wherein component (B) is formed completely of glass fibres.

27. The method according to claim 16, wherein the at least one aliphatic polyamide (A1) has a solution viscosity determined according to ISO 307:2013 on a solution of 0.5 g polymer in 100 g m-cresol at 20° C. in the range of ηᵣₑₗ=1.6 to 3.0, and/or
the at least one transparent polyamide (A2) has a solution viscosity (ηᵣₑₗ) determined according to ISO 307:2013 on a solution of 0.5 g polymer in 100 g m-cresol at 20° C. in the range of 1.4 and 2.2, and/or
has a glass transition temperature T_{g} determined according to ISO 11357-2:2013 at a heating rate of 20° C./min above 90° C., and/or
the at least one aliphatic polyamide (A3) has a solution viscosity (ηᵣₑₗ) determined according to ISO 307:2013 on a solution of 0.5 g polymer in 100 g m-cresol at 20° C. in the range of ηᵣₑₗ=1.5 to 3.0, preferably in the range of ηᵣₑₗ=1.6 to 2.6.

28. The method according to claim 16, wherein:
the at least one transparent polyamide (A2) is an amorphous polyamide with a melting enthalpy determined according to ISO 11357-3:2013 at a heating rate of 20° C./min of less than 4 J/g, or
the at least one transparent polyamide (A2) is a microcrystalline polyamide with a melting enthalpy determined according to ISO 11357-3:2013 at a heating rate of 20° C./min in the range of 4 to 25 J/g.

29. The method according to claim 16, wherein, respectively relative to the total polyamide moulding compound,
component (A) is in the range of 42 to 90% by weight, and/or
component (B) is in the range of 10-55% by weight, and/or
component (C) is in the range of 0.1-3.0% by weight.

30. The method according to claim 16, wherein, relative to the polyamide mixture (A), the proportion of the at least one polyamide (A1) is 50 to 95% by weight, and the proportion of the mixture made of the at least one polyamides (A2) and (A3) is 5 to 50% by weight,
or
the proportion of the at least one polyamide (A1) is 50 to 90% by weight, the proportion of the at least one polyamide (A2) is 5 to 25% by weight, and the proportion of the at least one polyamide (A3) is 5 to 25% by weight.

31. A polyamide moulding compound comprising:
(A) 77-100% by weight of a polyamide mixture consisting of components (A1), (A2) and (A3),
(A1) 50-95% by weight of at least one aliphatic polyamide selected from homopolyamides 616, 516 or 916, and copolyamides 516/616, 516/916, 616/1016, 616/610, 616/612 or 616/614 and mixtures thereof, the proportion of 616, 516 or 916 in the copolyamides constituting at least 50% by mol; and
(A2) 0-50% by weight of at least one transparent polyamide VX/WX/VY/WY/Z, at least one of the polyamide units WX or WY being present and the abbreviations V to Z being derived from the following molecules: V: 1,6-hexanediamine, 1,10-decanediamine; W: MACM, PACM, TMDC; X: 1,16-hexadecanedioic acid; Y: terephthalic acid, isophthalic acid; Z: laurinlactam, aminoundecanoic acid, and α,ω-aminododecanoic acid;
(A3) 0-50% by weight of at least one aliphatic polyamide selected from the group consisting of PA11, PA12, PA1010, PA1012, PA1014, PA1212, PA1214, and PA1016;
the sum of (A1) to (A3) producing 100% by weight of (A);
(B) 0-20% by weight of fillers and/or reinforcing materials;
(C) 0-3% by weight of aids and/or additives;
the sum of components (A) to (C) constituting 100% by weight.

32. A method for producing an article in a continuous or discontinuous process, the method comprising shaping a polyamide compound according to claim 31 into the article.

33. The method of claim 32, wherein the continuous process is extrusion process and the discontinuous process is injection moulding.

34. The method according to claim 32, wherein the article is a film, fibre, pipe, or covering.
